(19) United States
(12) Patent Application Publication
(10) Pub. No.: US 2009/0187593 A1
(43) Pub. Date: Jul. 23, 2009

(54) Methods and Apparatus for Targeted Media Content Delivery and Acquisition in a Wireless Communication Network

(75) Inventors: An Mei Chen, San Diego, CA (US); Gordon Kent Walker, Poway, CA (US); Ravinder Paul Chandhok, Poway, CA (US); Paul E. Jacobs, La Jolla, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/133,975

(22) Filed: Jun. 5, 2008

Related U.S. Application Data
(60) Provisional application No. 61/021,719, filed on Jan. 17, 2008.

(51) Int. Cl. G06F 17/30; G06Q 30/00

(52) U.S. Cl. 707/104.1; 705/10; 707/E17.044; 707/E17.046

(57) ABSTRACT

Apparatus, methods and computer program products are provided for targeted media content acquisition on a wireless device. The wireless device selects media content to receive based on a resident user profile, locally constructed based on passive user data, active user data and user inference data drawn from the passive and active user data. Additionally, aspects provide for grouping of the media content prior to distribution, including communicating groups of related data in unison to limit the number of times that a wireless device needs to tune-in and/or wake-up to receive the media content, thereby reducing power consumption.

### CLAIM OF PRIORITY UNDER 35 U.S.C. §119

The present Application for patent claims priority to Provisional Application No. 61/021,719 entitled “Methods and Apparatus for Targeted Media Content Delivery and Acquisition in a Wireless Communication Network” filed Jan. 17, 2008, and is related to co-pending Utility application Ser. No. 11/561,310 entitled “Apparatus and Methods of Distributing Content and Receiving Selected Content Based on User Personalization Information” filed Nov. 17, 2006, and related to co-pending Utility application Ser. No. 11/614,863 entitled “Apparatus and Methods of Selective Collection and Selective Presentation of Content” filed Dec. 21, 2006; and assigned to the assignee hereof.

### BACKGROUND

1. Field

The described aspects relate to media content distribution systems, and more particularly, to apparatus and methods of grouping media content for distribution based on group characteristics, and selecting media content from the group based on a user profile that may include passive user data, and/or active user data, and/or user inference data.

2. Background

Communication networks have been designed to deliver media content to recipients. For example, communication networks may comprise a broadcast or multicast system, which transmit information to multiple recipients at the same time. These types of delivery technologies address the problem of cost effective delivery of media content usable by a large number of network endpoints. Despite its network utilization advantages, however, multicast technology presents a challenge in addressing personalized and narrow-interest media content delivery.

Further, the desire for mobile consumption of media content is increasing along with the increasing popularity and functionality of mobile communication devices.

Additionally, to catch the attention of the user and provide a more efficient use of the user's time, it is desirable for media content to be directed to the specific interests or preferences of the device user. However, current methods of defining user preferences are limited to passive information that a user provides, for example, information that a user inputs into a conventional user profile. Such passive information does not account for the active or dynamic data associated with the device user.

Further, from the mobile communication device standpoint, memory limitations typically limit the amount of media content that a device may receive and battery power limitations are not readily conducive to frequently waking-up (i.e., powering-up the receiver) to receive numerous multicast/broadcast media content deliveries. Thus, while targeted media content acquisition, such as advertising or marketing media content, is a desirable goal in the wireless environment, the competing interests of memory and battery power consumption should be considered to insure an acceptable user experience.

Thus, improved systems and method of distributing and receiving media content of interest to the device user are desired. The desired systems and methods should provide intuitive targeted media content delivery and acquisition, such that the user preferences are not limited to static user data but instead rely on active user data and/or deduce user inferences. In addition, the desired systems and methods should limit the amount of memory consumption on the wireless device and limit the amount of battery power consumption used in the acquisition and presentation of the media content on the wireless communication device.

### SUMMARY

Present aspects provide for methods, devices, systems and computer program products for targeted media content acquisition on a wireless communication device. Aspects provide for defining media content metadata at a media distribution system and grouping or classifying media content according to characteristics defined in the metadata. Metadata associated with a defined group is communicated to wireless communication devices, which, in turn, selects which media content from the group to acquire based on a user profile. The user profile may include passive user data, active user data and user inferences drawn from the passive and active user data. Subsequently, the media distribution system broadcasts or otherwise communicates the media content groups and the wireless device acquires the selected media content from the group. By broadcasting groups of media content, as opposed to individual media content, the wireless communication only needs to wake-up to receive selected media content from the group during a single window of time, thus providing for a more efficient process in terms of battery power consumption.

Thus, present aspects provide for selecting media content to acquire at the wireless communication device level, without having to respond to a request for user data or provide user specific data to a network entity. Thus, by not determining which media content to send to the device at the network level, the system allows the user of the wireless device to maintain privacy. Additionally, by using dynamic user data and determining user inferences from the user data, the media content that is acquired can be narrowly targeted based on precise user preferences and the user's current state/environment/actions. This minimizes the amount of media content that the wireless device receives that is not of interest and/or beneficial to the user of the wireless device.

In one aspect, a method for targeted media content acquisition on a wireless communication device is defined. The method includes generating one or more user profiles for users of a wireless communication device and storing the one or more user profiles in a wireless communication memory. The user profile includes user data. The method additionally includes, receiving metadata associated with a group of media content, wherein the group of media content is based on a predetermined match between group characteristics and media content metadata. Further, the method includes determining a correlation between the user data in one or more user profiles and the metadata, generating a schedule to listen for selected media content from the group of media content based on the correlation between the user data and the metadata, and storing the schedule in the wireless communication device memory.

In some aspects, generating the user profiles may include determining one or more user inferences based on at least one of passive user data and active user data, such that the user profile includes any combination of passive user data, active user data and/or user inferences. In other aspects, determining a correlation between the user data and the metadata may include determining one or more user inferences data based on the user data in one or more user profiles and determining a correlation between the user inference data and the metadata.

The method may optionally further include receiving, typically by broadcast or multicast reception, selected media content from the group of media content and storing the selected media content in wireless communication device memory. In one aspect, receiving the selected media content from the group may include triggering the wireless communication device to wake-up at predetermined times based on the generated schedule. Additionally, the method may optionally include determining when to present the received selected media content. The determination of when to present the media content may be based on one or a combination of the user data in the user profile, media content metadata and dynamic user use data, such as the current primary media content being presented, current device location and current time.

Additionally, the method may optionally include monitoring an expiration attribute for each of the received selected media content and deleting from device memory the received selected media content based on monitoring the expiration attribute and determining that selected ones of the received media content have expired.

Another related aspect is provided for by at least one processor. The processor is configured to include a first module for generating one or more user profiles for users of a wireless communication device, and a second module for storing the one or more user profiles in the wireless communication memory. The user profiles include user data. The processor is additionally configured to include a third module for receiving metadata associated with a group of media content, wherein the group of media content is based on a predetermined match between group characteristics and media content metadata. Further, the processor includes a fourth module for determining a correlation between the user data in the user profiles and the metadata, a fifth module for generating a schedule to listen for selected media content from the group of media content based on the correlation between the user data and the metadata, and a sixth module for storing the schedule in the wireless communication device memory.

An additional related aspect is defined by a computer program product that includes a computer-readable medium. The medium includes a first set of codes for causing a computer to generate one or more user profiles for users of a wireless communication device and a second set of codes for causing the computer to store the one or more user profiles in a memory. The user profiles include user data. The medium additionally includes a third set of codes for causing the computer to receive metadata associated with a group of media content, wherein the group of media content is based on a predetermined match between group characteristics and media content metadata. Further, the medium includes a fourth set of codes for causing a computer to determine a correlation between the user data in one or more user profiles and the metadata, a fifth set of codes for causing a computer to generate a schedule to listen for selected media content from the group of media content based on the correlation between the user data and the metadata, and a sixth set of codes for causing a computer to store the schedule in the wireless communication device memory.

Yet another related aspect is provided for by a wireless communication device that includes means for generating one or more user profiles for users of a wireless communication device and means for storing the one or more user profiles in a wireless communication memory. The user profile includes user data. The wireless communication device additionally includes means for receiving metadata associated with a group of media content, wherein the group of media content is based on a predetermined match between group characteristics and media content metadata. Further, the wireless communication device includes means for determining a correlation between the user data in one or more user profiles and the metadata, means for generating a schedule to listen for selected media content from the group of media content based on the correlation between the user data and the metadata, and means for storing the schedule in the wireless communication device memory.

A further aspect is defined by a wireless communication device that includes a computer platform including a processor and a memory. The wireless communication device also includes a user profile module stored in the memory and executable by the processor. The user profile module includes user profile logic operable to generate one or more user profiles that include user data and store the one or more user profiles in the memory. The wireless communication device also includes a media content metadata processing module stored in the memory and executable by the processor. The media content metadata processing module includes media content metadata processing logic operable to receive metadata associated with a group of media content, wherein the group of media content is based on a predetermined match between group characteristics and media content metadata. Further, the media content metadata processing logic is further operable to determine a correlation between the user data and the metadata, generate a schedule for listening for selected media content from the group of media content based on the correlation, and store the schedule in the memory.

In some aspects of the device, the user profile logic may further be operable to determine one or more user inferences based on at least one of passive user data and active user data, such that the user profile includes any combination of passive user data, active user data and user inference data. In other aspects of the device, the media content metadata processing logic may further be operable to determine one or more user inferences based on the user data and determine a correlation between the one or more user inferences and the metadata.

Additionally, the device may optionally include a media content acquisition module stored in the memory and executable by the processor. The media content acquisition module includes media content acquisition logic operable to receive the selected media content from the group of media content and store the selected media content in the memory. Additionally, the media content acquisition logic may be further operable to trigger the wireless communication device to wake-up at predetermined times based on the generated schedule. The device may also optionally include a media content presentation module stored in the memory and executable by the processor. The media content presentation module includes media content presentation logic operable to determine when to present received selected media content based on one or a combination of the user data, media content metadata and dynamic user usage data, such as the current media content being presented on the device, current location of the device/user, current time and the like. The media content presentation logic may also be operable to monitor an expiration attribute for each of the received selected media content and delete from the memory selected ones of the received selected media content based on monitoring the expiration attribute for each received selected media content and determining that selected ones of the received selected media content have expired.

A method for delivering targeted media content in a communication network defines another aspect. The method includes obtaining metadata for a plurality of media content, classifying each of the predetermined plurality of media content into one or more groups of media content based on the metadata, determining a schedule for communicating the one or more groups of media content based on one or more delivery attributes and storing the schedule in a network database.

The method may optionally include communicating the one or more groups of media content according to the determined schedule. In one specific aspect, the metadata is communicated to a plurality of wireless communication devices prior to communicating the one or more groups of media content according to the determined schedule.

According to the method, obtaining metadata for the plurality of media content may include obtaining target attributes that characterize the media content for a targeted recipient, such that the metadata may include targeted gender, targeted income, targeted education, targeted age, targeted geographic location, media content type, media content size, required bandwidth for wireless transmission, media content characteristics, and expiration date. Additionally, classifying each of the plurality of media content may further include classifying based on a predetermined classification routine each of the plurality of media content into one or more groups of media content based on the metadata.

Additionally, according to the method, determining a schedule for communicating the one or more groups of media content based on one or more delivery attributes may define the delivery attributes as one or more of available network resources, priority of media content, priority of the group of media content, required time of day for delivery, value of the media content, value of the group of media content, and potential quantity of wireless communication devices to whom the group of media content is to be communicated. Determining a schedule may further include determining an amount of redundancy needed to be added to the group of media content and/or determining a number of repetitions for communicating the group of media content and/or determining one or more communication times for the group of media content.

A related aspect is defined by at least one processor. The processor is configured to include a first module for obtaining metadata for a plurality of media content, a second module for classifying each of the plurality of media content into one or more groups of media content based on the metadata, a third module for determining a schedule for communicating the one or more groups of media content based on one or more delivery attributes and a fourth module for storing the schedule in a network database.

Another related aspect is provided for by a computer program product that includes a computer-readable medium. The medium includes a first set of codes for causing a computer to obtain metadata for a plurality of media content, a second set of codes for causing the computer to classify each of the plurality of media content into one or more groups of media content based on the metadata, a third set of codes for causing the computer to determine a schedule for communicating the one or more groups of media content based on one or more delivery attributes and a fourth set of codes for causing the computer to store the schedule in a network database.

A further related aspect is defined by a network device. The device includes means for obtaining metadata for a plurality of media content, means for classifying each the media content into one or more groups of media content based on the metadata, means for determining a schedule for communicating the one or more groups of media content based on one or more delivery attributes; and means for storing the schedule in a network database.

Another aspect is provided for by a network device. The network device includes a computer platform including a processor and a memory. The device also includes media content processing logic operable to define metadata for a plurality of media content, media content classifying logic operable to classify each of the plurality of media content into one or more groups of media content based on the metadata and a media content scheduler operable to determine a schedule for communicating the one or more groups of media content based on one or more communication attributes. The device may, optionally, also include a communication module operable to communicate the one or more groups of media content according to the determined schedule and/or operable to communicate metadata associated with the one or more groups of media content.

In some aspects, the media content processing logic may be further operable to define the metadata as including attributes that characterize the media content for a target recipient. The media content scheduler may be further operable to determine an amount of redundancy needed to be added to the group of media content, a number of repetitions for communicating the group of media content and/or one or more communication times for the group of media content.

Thus, present aspects provide for devices, apparatus, systems, methods and computer program products for targeted media content acquisition on a wireless device. The wireless devices select media content to receive locally, at the wireless device, based on a user profile that may include passive user data, active user data and user inferences drawn from the passive and active user data. By selecting the media content locally, the wireless device does not have to supply personal information to the network, thereby, maintaining a level of user privacy. By using passive and active user data, in addition to user inferences, the media content that is acquired by the wireless device is limited to media content that is highly tailored to the user and the user's current actions. Additionally, aspects provide for grouping of the media content at the network device, so that metadata associated with the group can be communicated within a given time window, and the media content within a group can be communicated within a given time window, thereby reducing the number of times that a wireless device needs to wake-up to receive the media content, and thus reducing power consumption.

### BRIEF DESCRIPTION OF THE DRAWINGS

The disclosed aspects will hereinafter be described in conjunction with the appended drawings, provided to illustrate and not to limit the disclosed aspects, wherein like designations denote the elements, and in which:

FIG. 1 is a block diagram of a system for targeted media content acquisition on a wireless communication device, according to an aspect;

FIG. 2 is a block diagram of a wireless communication device configured for targeted media content acquisition, according to an aspect;

FIG. 3 is a block diagram of a user profile module executable on a wireless communication device configured for targeted media content acquisition, according to an aspect;

FIG. 4 is a block diagram of an inference profiling module executable on a wireless communication device configured for targeted media content acquisition, according to an aspect;

FIG. 5 provides examples of user inferences, according to an aspect;

FIG. 6 is a block diagram of a media content metadata processing module executable on a wireless communication device configured for targeted media content acquisition, according to an aspect;

FIG. 7 is a block diagram of a media content acquisition module executable on a wireless communication device configured for targeted media content acquisition, according to an aspect;

FIG. 8 is a block diagram of a media content presentation module executable on a wireless communication device configured for targeted media content acquisition, according to an aspect;

FIG. 9 is a block diagram of a media distribution system for distributing targeted media content to a wireless communication device, according to an aspect;

FIG. 10 is a block diagram of a media content classifying module executable in a media distribution system, according to an aspect;

FIG. 11 is a block diagram of a media content delivery scheduler module executable in a media distribution system, according to an aspect;

FIG. 12 is a flow diagram of a method for distributing targeted advertising media content to a wireless communication device, according to an aspect;

FIG. 13 is a flow diagram of a method for acquiring and presenting targeted advertising media content on a wireless communication device, according to an aspect;

FIG. 14 is a flow diagram of a method for acquiring and presenting targeted media content on a wireless communication device, according to an aspect;

FIG. 15 is a flow diagram of a method for generating a user profile on a wireless communication device configured for targeted media content acquisition, according to an aspect;

FIG. 16 is flow diagram of a method for defining media content metadata, classifying media content and determining a delivery schedule in a media distribution system, according to an aspect.

### DETAILED DESCRIPTION

The present devices, apparatus, methods, computer-readable media and processors now will be described more fully hereinafter with reference to the accompanying drawings, in which aspects of the invention are shown. The devices, apparatus, methods, computer-readable media and processors, however, may be embodied in many different forms and should not be construed as limited to the aspects set forth herein; rather, these aspects are provided so that this disclosure will be thorough and complete, and will fully convey the scope of the invention to those skilled in the art. Like numbers refer to like elements throughout.

The various aspects are described herein are in connection with a wireless communication device. A wireless communication device can also be called a subscriber station, a subscriber unit, mobile station, mobile, remote station, access point, remote terminal, access terminal, user terminal, user agent, a user device, a client or user equipment. A subscriber station may be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem.

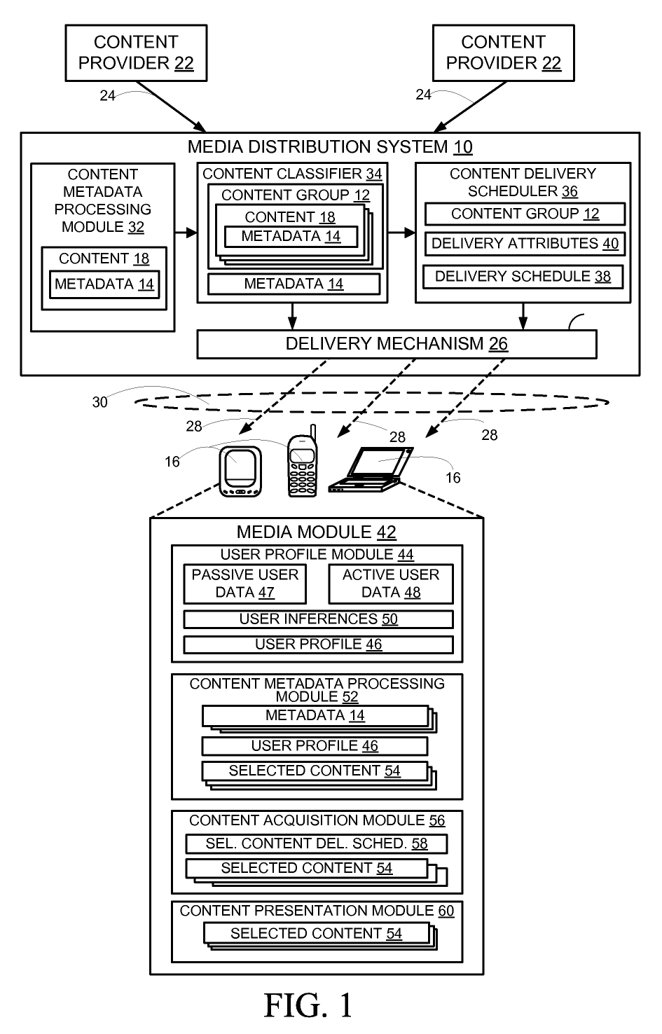

Referring to FIG. 1, a system for targeted media content acquisition on a wireless communication device is depicted. The system includes a media distribution system 10 that is operable to distribute a media content groups 12 and metadata 14 associated with the groups to a plurality of wireless communication devices 16 that are configured to select media content 18 from the groups 12 for acquisition based correlations, determined at the wireless device, between the metadata 14 and user profiles 46.

The media distribution system 10 is operable to receive media content 18 from one or more media content providers 22. The content providers 22 may provide all or some portion of the media content 18 to the media distribution system 10. The media content 18 may include, but is not limited to, video content, audio content, multimedia content, real-time content, non-real time content, also referred to as “clips,” scripts, programs, data or any other type of suitable media content. In addition, the media content 18 may include, but is not limited to, subscribed programming, ad-hoc and/on-demand programming, advertising or any other form of media content presented during a break within and/or simultaneously with other primary media content. In some aspects, content providers 22 communicate with media distribution system 10 via a communication link 24, which may include any suitable type of wired and/or wireless communication interface.

The media distribution system 10 may comprise a delivery mechanism 26 that operates to create and transport media content flow 28, including media content groups 12 and metadata 14, across one or more data networks 30. For example, such a delivery mechanism may include a multicast delivery mechanism. In some aspects of multicasting, each media content flow 28 is a logical stream within a “multiplex”, which is a set of flows available in a given geographical area. Each flow 28 is able to deliver the same media content 18 to a plurality of endpoints at the same time, as the flow is available to any device tuning into the proper frequency, thereby avoiding scalability issues. Therefore, media distribution system 10 may be operable to transport media content 18 in a one-to-many fashion.

Media distribution system 10, which be embodied within one or multiple network devices, may include media content metadata processing module 32 operable for creating metadata 14 for each of the plurality media content 18. The media content metadata processing module 30 may be configured to create all or a portion of metadata 14 automatically according to associated logic, or the metadata 14 may be manually inputted by a media distribution operator or received from a third party, such as content provider 22. In accordance with present aspects, the metadata 14 may include attributes that characterize the media content 18 for targeted wireless devices 16.

The media distribution system 10 may also include a media content classifier module 34 operable for classifying the plurality of media content 18 into one or more media content groups 12. The content classifier module 34 may be configured to rely on logic, such as heuristic algorithm or the like, to classify some or a portion of the plurality of media content based on the metadata 14. In alternate aspects, classification may involve some level of manual input from a media distribution operator. In accordance with present aspects, media content classifier module 34 may be operable to assemble one or more media content groups 12 for delivery to targeted recipients. Grouping of media content allows the media distribution system 10 to subsequently transmit together the media content 18 that forms the group 12. As such, a wireless device 16 that desires to acquire media content 18 from the group 12 needs to wake up less often, when compared to non-grouped delivery systems, to receive relevant media content. Thus, according to some aspects, the described apparatus and methods improve wireless device performance, in terms of standby time and battery power consumption, by delivering media content 18 in content groups 12.

The media distribution system 10 may also include a content delivery scheduler 36 operable for determining a delivery schedule data 38 for media content groups 12 and/or for individual ones of media content 18. For example, content delivery scheduler 36 may determine delivery schedule data 38, such as a window of time in which the respective content can be received via a broadcast, based on one or more delivery attributes 40.

Additionally, the media distribution system 10 is be operable to communicate the metadata 14 and delivery schedule data 38 associated with a media content group 12 and/or with an individual one of media content 18 to the plurality of wireless devices 16. For example, the media distribution system may implement delivery mechanism 26 to multicast or otherwise communicate the metadata 14 and delivery schedule data 38 associated with a media content group 12 and/or with an individual one of media content 18 to the plurality of wireless devices 16. In some aspects, for example, the metadata 14 for an individual piece of content 18 and/or for a content group 12 may include the corresponding delivery schedule data 38.

The plurality of wireless communication devices 16 each include media module 42 that is operable to determine a user profile, determine selected media content based on a correlation between the user profile and media content metadata, and determine acquisition and presentation times for the selected media content. As such, media module 42 may include user profile module 44 operable to determine a user profile 46. The user profile module 44 is operable to profile user demographics and may include passive user data 47, active user data 48 and/or user inferences 50. Passive user data 47 may include information and/or data inputted by a user to a profile form, questionnaire or the like. Active user data 48 may include information and/or data related to user actions, such as content, network services or applications accessed, location or time of the day that content, network services and/or applications are accessed and the like. Additionally, active user data 48 may include dynamic information related to a user's current usage behavior. User inferences 50 are logically derived user assumptions based on any combination of passive user data and/or active user data.

The media module 42 may additionally include media content metadata processing module 52 operable for receiving the metadata 14 associated with a group 12 and determining correlations between the user profile 46 and the metadata 14. Based on the correlations between the user profile 46 and the metadata 14, the media content metadata processing module 52 determines selected content 54 and, based on metadata 14 for the selected content 54, determines the respective delivery schedule 58 for the selected content 54. The selected content 54 may be a subset of the content group 12 associated with the metadata 14, or the selected content 54 may comprise the content group 12 in its entirety.

The media module 42 may additionally include content acquisition module 56 operable to trigger the respective wireless device 16 to tune-in and/or powering-up the receiver, otherwise referred to as “waking-up the device,” according to the delivery schedule 58 to receive the selected content 54. Additionally, the content acquisition module 56 may be operable for determining an alternative or revised delivery schedule if the initial delivery schedule results in a delivery failure, for example, based on improper decoding of the media content.

Additionally, the media module 42 may include media content presentation module 58 that is operable to select an appropriate time to present or otherwise “play” the selected and acquired media content 54 on the wireless device 16. Determining an appropriate presentation time may be dictated by metadata 14 associated with the selected content 54, passive, active and dynamic information in the user profile 46, such as the network service, application or primary content currently being accessed/presented, and the like. The content presentation module 58 may additionally be operable to determine when selected media content 54 should be deleted from wireless device memory. Such as deletion determination may be based on, for example, an expiration date included in content metadata, how closely the selected content correlates to the user profile, network factors, and the like.

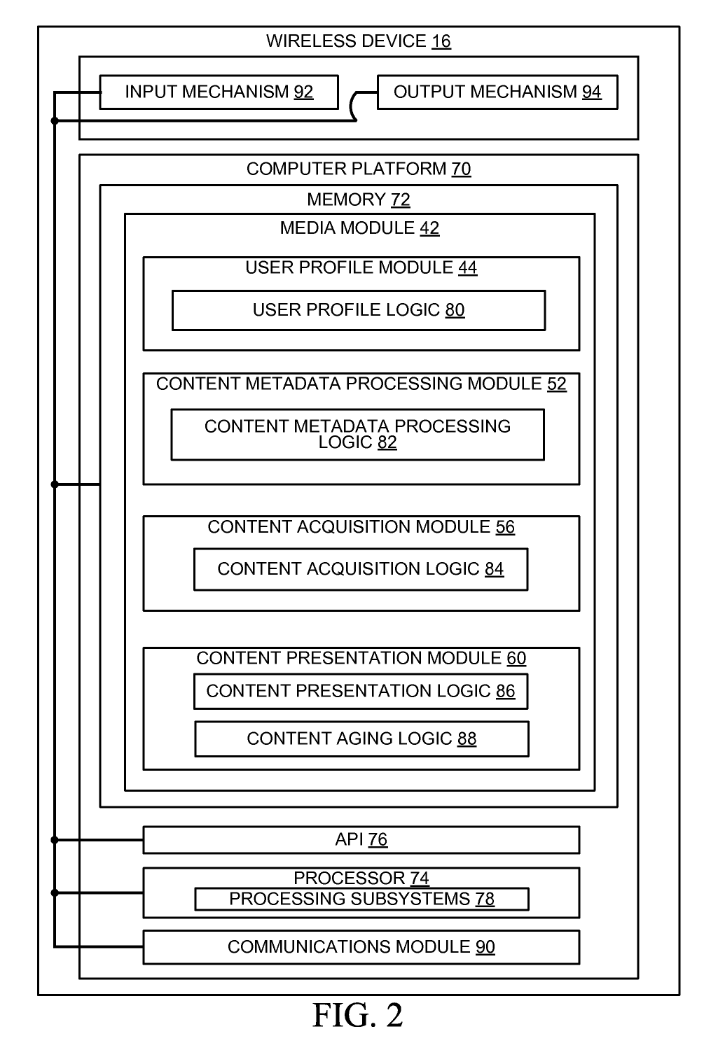

Referring to FIG. 2, according to one aspect, a detailed block diagram representation of wireless communication device 16 is depicted. The wireless communication device 16 may include any type of computerized, communication device, such as cellular telephone, Personal Digital Assistant (PDA), two-way text pager, portable computer, and even a separate computer platform that has a wireless communications portal, and which also may have a wired connection to a network or the Internet. The wireless communication device can be a remote-slave, or other device that does not have an end-user thereof but simply communicates data across the wireless network, such as remote sensors, diagnostic tools, data relays, and the like. The present apparatus and methods for targeted media content acquisition on a wireless communication device can accordingly be performed on any form of wireless communication device or wireless computer module, including a wireless communication portal, including without limitation, wireless modems, PCMCIA cards, access terminals, desktop computers or any combination or sub-combination thereof.

The wireless communication device 16 includes computer platform 70 that can transmit data across a wireless network, and that can receive and execute routines and applications. Computer platform 70 includes memory 72, which may comprise volatile and nonvolatile memory such as read-only and/or random-access memory (RAM and ROM), EPROM, EEPROM, flash cards, or any memory common to computer platforms. Further, memory 72 may include one or more flash memory cells, or may be any secondary or tertiary storage device, such as magnetic media, optical media, tape, or soft or hard disk.

Further, computer platform 70 also includes processor 74, which may be an application-specific integrated circuit (“ASIC”), or other chipset, processor, logic circuit, or other data processing device. Processor 74 or other processor such as ASIC may execute an application programming interface (“API”) layer 76 that interfaces with any resident programs and/or modules, such as media module 42 and related sub modules 44, 52, 56 and 60, stored in the memory 72 of wireless device 16. API 76 is typically a runtime environment executing on the respective wireless device. One such runtime environment is Binary Runtime Environment for Wireless® (BREW®) software developed by Qualcomm, Inc., of San Diego, Calif. Other runtime environments may be utilized that, for example, operate to control the execution of applications on wireless computing devices.

Processor 74 includes various processing subsystems 78 embodied in hardware, firmware, software, and combinations thereof, that enable the functionality of wireless device 16 and the operability of the wireless communication device on a wireless network. For example, processing subsystems 78 allow for initiating and maintaining communications, and exchanging data, with other networked devices. In aspects in which the communication device is defined as a cellular telephone, the processing subsystems 78 may include, but are not limited to, one or more of: sound, non-volatile memory, file system, transmit, receive, searcher, layer 1, layer 2, layer 3, main control, remote procedure, handset, power management, digital signal processor, messaging, call manager, Bluetooth® system, Bluetooth® LPOS, position engine, user interface, sleep, data services, security, authentication, USIM/SIM, voice services, graphics, USB, multimedia such as MPEG, GPRS, etc (all of which are not individually depicted in FIG. 2 for the sake of clarity).

For the disclosed aspects, processing subsystems 78 of processor 74 may include any subsystem components that interact with the media module 42 and the related sub-modules 44, 52, 56, and 60. For example, processing subsystems 78 may include locating and tracking devices/applications that are implemented in conjunction with user profile module 44 and the content presentation module 60 to acquire dynamic location information that is used in selecting targeted media content and determining when to present the media content. Alternatively, one or more of the processing subsystems 78 may be configured as modules/applications and/or logic stored in memory 72.

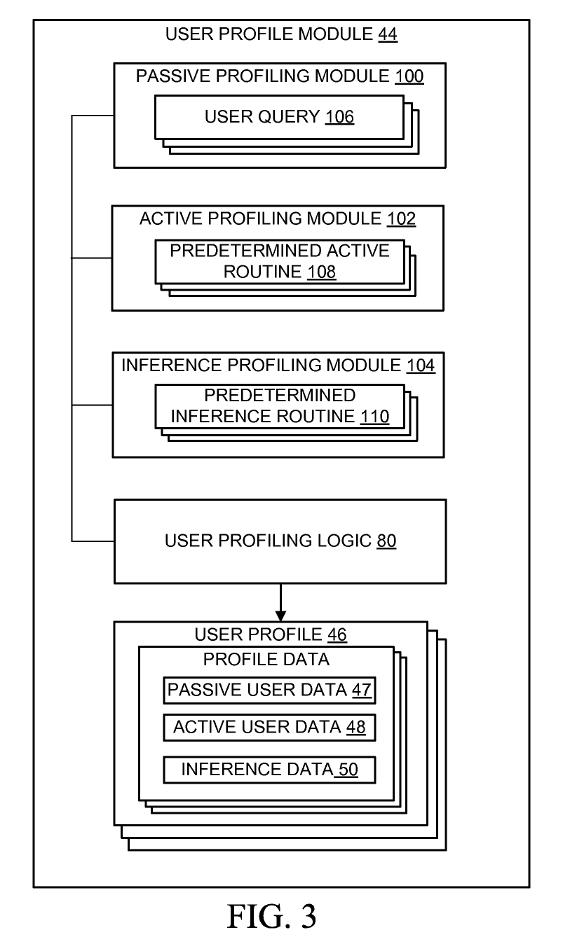

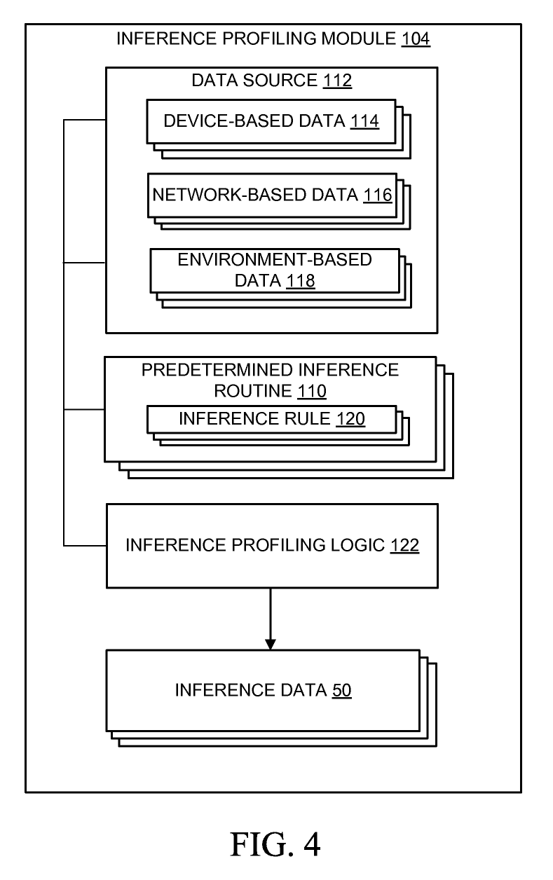

Further, as noted, the memory of computer platform 50 includes media module 42 operable for acquiring targeted media content. The media module 42 may include user profile module 44 having user profile logic 80 operable for determining a user profile from amongst passive user data, active user data, dynamic user data and user inference data. Further detailed description of the user profile module 42 is provided in relation to FIGS. 3 and 4, discussed infra.

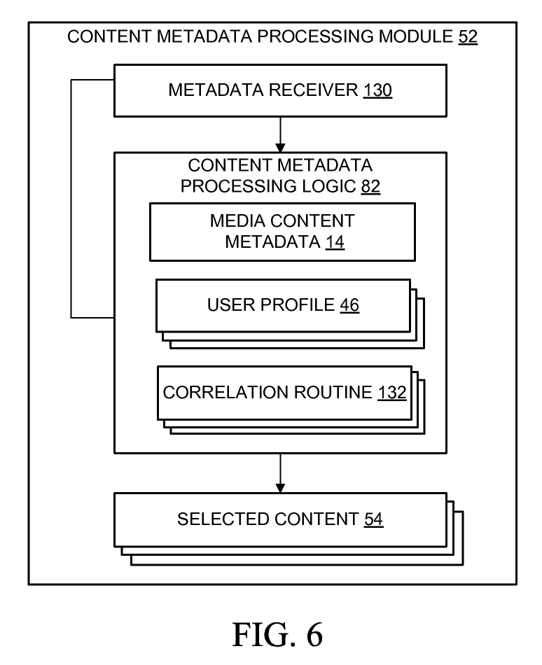

The media module 42 also includes content metadata processing module 52 having content metadata processing logic 82 that is operable for receiving metadata associated with a media content group and determining correlations between the metadata and the user profile for the purpose of selected media content to receive. Additionally, the content metadata processing logic 82 is operable for determining the delivery schedule of the selected media content based on delivery schedule information in the selected content metadata. Further detailed description of the content metadata processing module 52 is provided in relation to FIG. 6, discussed infra.

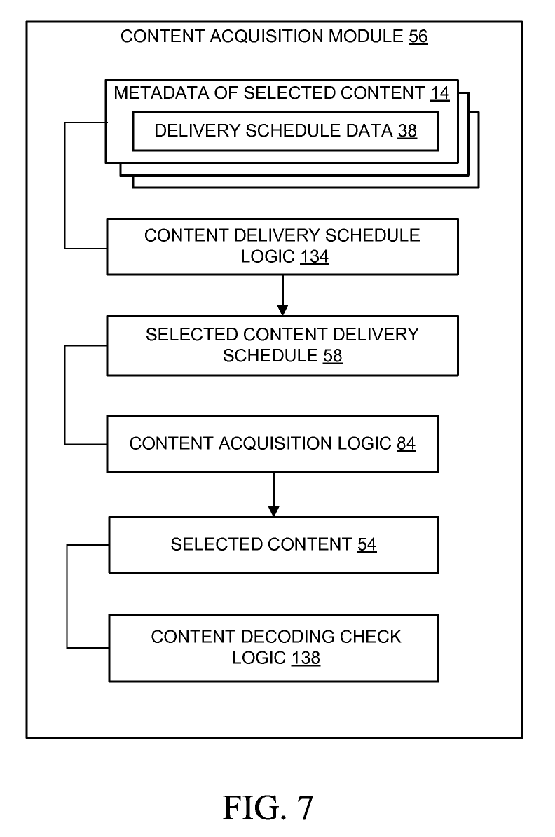

The media module 42 may also include content acquisition module 56 having content acquisition logic 84 operable to determine when to tune-in and/or powering-up the receiver (i.e., “wake-up”) the wireless device to receive the delivered, selected media content, which is delivered according to the delivery schedule. Additionally, the content acquisition logic may determine alternate delivery schedules and, thus alternate wake-up times, if the initial delivery of the selected content fails, for example if the selected content is unable to be properly decoded. Further detailed description of the content acquisition module 56 is provided in relation to FIG. 7, discussed infra.

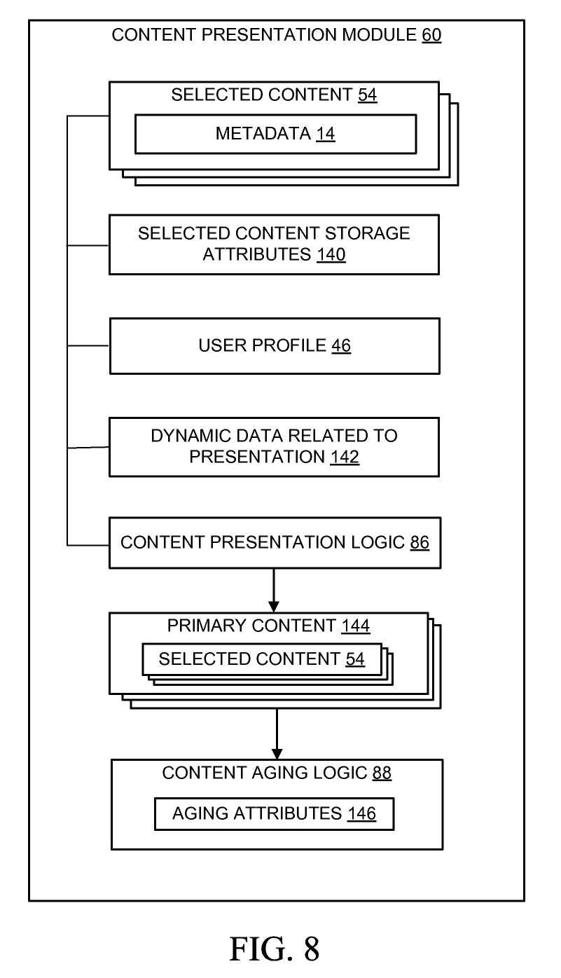

The media module 42 may additionally include content presentation module 60 having content presentation logic 86 operable to determine presentation times for the selected media content based on one or more presentation attributes. Additionally, content presentation module 60 may include content aging logic 88 operable to determine when the selected media content will be deleted from device memory based on one or more aging attributes. Further detailed description of the content presentation module 60 is provided in relation to FIG. 8, discussed infra.

Wireless communication device 16 may additionally include communication module 90 that is operable for receiving the delivery of selected media content. In this regard, communications module 90 may be triggered to tune-in and/or wake-up to receive the delivery, for example, the multicast communication, of the selected media content 54 according to the directive of the content acquisition logic 84.

Additionally, as previously noted, wireless communication device 16 may include input mechanism 92 for generating inputs into communication device, and output mechanism 94 for generating information for consumption by the user of the communication device. For example, input mechanism 92 may include a mechanism such as a key or keyboard, a mouse, a touch-screen display, a microphone, etc. In certain aspects, the input mechanisms 92 provide for user input to interface with an application, such as media module 42. Further, for example, output mechanism 94 may include a display, an audio speaker, a haptic feedback mechanism, etc. In the illustrated aspects, the output mechanism 94 may include a display operable to present the selected media content.

Referring now to FIG. 3, according to an aspect, depicted is a detailed block diagram of the user profile module 44 of media module 42. The user profile module 44 may include user profiling logic 80 operable to execute passive profiling module 100, and/or active profiling module 102 and/or inference profiling module 104. In addition, to compiling user profile 46 from a combination of passive user data 47, active user data 48 and user inferences 50, user profiling logic 80 may determine the frequency by which active user data is updated and the frequency by which user inferences are determined. In this regard, user profiling logic 80 may determine the time period or aging attribute for retaining active user data 48 and/or user inference 50, or for prompting a user to provide updated passive user data 47.

Passive profiling module 100 includes a plurality of user queries 106 that may comprise a user questionnaire, user survey or the like presented to one or more users of the wireless device. User inputs to the user queries 106 result in passive user data 47 that is stored in the user profile 46. User queries 106 may be presented to the user via the media module 42, a general device configuration application or any other application/module accessible on the wireless communication device that interacts with user module 42. User queries 106 may result in the collection of any personal user information, such as information related to targeted media content acquisition. For example, user queries 106 may include queries relating to address, age, gender, marital status, income, and the like.

Active profiling module 102 includes one or more predetermined active profile routines 108 able to determine active user data that is related to targeted media content acquisition. For example, predetermined active profile routines 108 may track the content, applications and/or network services that users acquire and access, the time of day and/or day of the week that the user access content, applications or network services, the location of the user when content, applications or network services are accessed and any other data related to user usage behavior with respect to the wireless device 16. Further, active profiling provides for historical user usage behavior data and/or dynamic user usage data. Thus, active profiling results in active user data 48 that is stored in the user profile 46.

Inference profiling module 104 includes inference profiling logic 122 that executes one or more predetermined inference routines 110 operable for determining a user inference based data from one or more data sources. User inferences are typically determined based on dynamic user usage behavior, such as content, application, or network currently being accessed/viewed, current location where content, application or network service is being accessed/viewed, current time of day or day of week at which content, application or network service is being accessed, viewed or the like.

FIG. 4 provides a detailed block diagram of the inference profiling module 104. Inference profiling module 104 includes various data sources 112 that include data used in determining user inferences 50. For example, data sources 112 may include device-based data 114, network-based data 116, environmental-based data 118 or the like. Device-based data 114 may include, but is not limited to, data such as content or applications currently being accessed or executed on the wireless communication device, network services, such as Internet web sites previously accessed, and purchasing history, such as previously purchased applications, games and the like. Network-based data 116 may include, but is not limited to, data such as network services currently being accessed, such as Internet web sites or services currently being accessed. Environmental-based data 118 may include, but is not limited to, data such as current time, current geographic position/location of the device, stationary or motion state of the device, building and/or business information corresponding with a given position/location, event information associated with a given building and/or business, and the like.

The inference profiling module 104 includes one or more predetermined inference routines 110 that include one or more inference rules 120. An inference rule defines the specific sets and/or combinations of user data, for example, device-based data 114, and/or network-based data 116, and/or environmental-based data 118, that is utilized to determine a user inference 50. Based on determined user inferences 50, the wireless device 16 can target the acquisition of media content 18 that is related to the determined inferences.

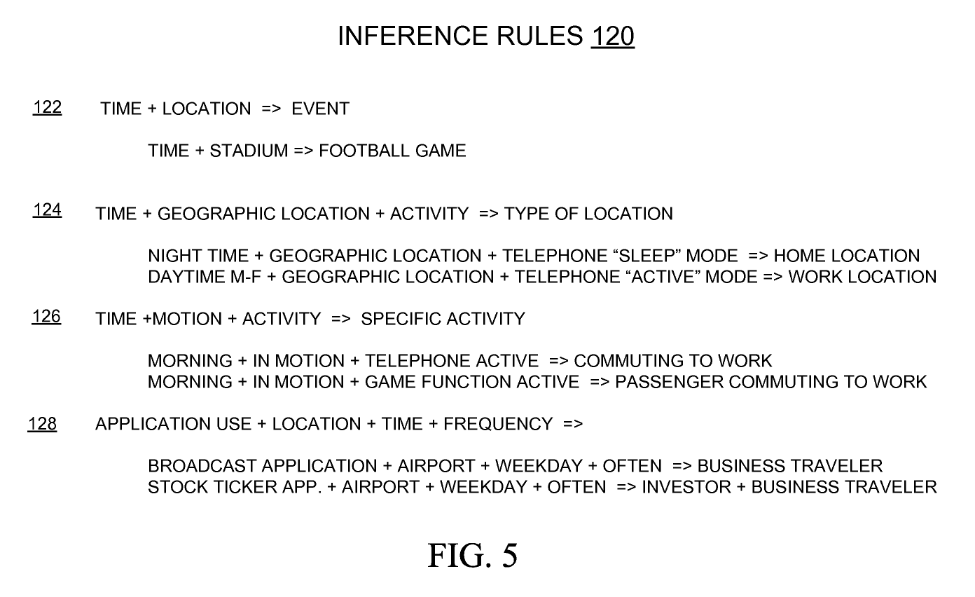

FIG. 5 provides various examples of inference rules 120. For example, inference rule 122 defines a time and a geographic location to determine a specific event inference. Specifically, if the wireless device is located at a stadium at a specific time, the inference may be determined that the user of the device is attending a football game and, as such, has interest in football. In another example, inference rule 124 defines a time, a geographic location and an activity to determine a specific location type inference. Specifically, if the wireless device is continually located at a specific geographic location during the night time and the cellular telephone function is in a “sleep” mode or otherwise disabled, the inference may be determined that the user/device is located at their residence. Conversely, if the wireless device is continually located at a specific location during 8 am-5 pm, Monday through Friday and the cellular telephone function is an “active” mode or otherwise enabled, the inference may be determined that the user/device is located at a place of work.

According to a further example, inference rule 126 defines a time, an environmental state and an activity to determine a specific activity inference. Specifically, if the wireless device is in motion during 7 am-8 am, Monday through Friday and the cellular telephone is active during this time period, the inference may be determined that the user is a driver commuting to work. Conversely, if the wireless device is continually in motion during 7 am-8 am, Monday through Friday and a gaming application is active during this time period, the inference may be determined that the user is a passenger commuting to work.

In yet another example, inference rule 128 defines an active application, a location, a time and a frequency to determine a user characteristic inference. Specifically, if the user/wireless device is frequently located at an airport during a weekday and receives broadcast or multicast content during this time period, the inference may be determined that the user is a business traveler. In the same regard, if the user/wireless device is frequently located at an airport during a weekday and receives stock market content, accesses a stock ticker network service or the like, then the inference may be determined that the user is a business traveler and an active investor.

Referring to FIG. 6, a detailed block diagram of content metadata processing module 52 is depicted. Content metadata processing module 52 includes metadata receiver 130 operable for receiving metadata 14 that is communicated from a media content distribution system prior to receiving the media content that is associated with the metadata. In one aspect, the metadata receiver 130 will receive metadata 14 that is broadcasted or multicasted from a media content distribution system. The metadata receiver 130 may be configured to receive metadata 14 associated with a media content group 12 and/or receive metadata 14 associated with an individual media content item 18.

The content metadata processing module 52 additionally includes content metadata processing logic 82 operable to implement one or more correlation routines 132 to determine correlations between user data in the one or more user profiles 46 and the metadata 14. Based on determined correlations, the content metadata processing logic 82 will determine selected content 54 that are associated with the metadata. In one aspect, for example, when the metadata 14 is associated with a group 12 of media content, the determined correlations between the metadata 14 and user data in the user profiles 46 will result in selected content 54 from the group 12 of media content.

FIG. 7 is detailed block diagram of a media content acquisition module 56, according to an aspect. The content acquisition module 56 includes content delivery schedule logic 134 operable for determining a delivery schedule 58 for the selected content 58. The delivery schedule 58 may be logically determined from delivery schedule data 38 included within the metadata 14 of, or corresponding to, the selected media content 58. The media content acquisition module 56 includes content acquisition logic 84 that is operable to cause the wireless device receiver to tune-in and/or “wake-up” to listen for the broadcast/multicast of the selected content 54 according to the delivery schedule 58. In certain aspects, for example when the media content is grouped according to media content characteristics and communicated as a group, triggering the wireless device to “wake-up” may be a one-time only occurrence to acquire the selected content 58 from the group, thereby reducing the amount of battery power consumed in the “wake-up” process.

The content acquisition module 56 may additionally include content decoding check logic 138 operable to determine if received selected content 54 have been properly decoded. If the content decoding check logic 138 determines the received selected content is not properly decoded, the logic may determine the next delivery time for the selected content and invoke the content acquisition logic 84 to “wake-up” to listen for the broadcast/multicast of the selected content 54 according to the next delivery time. The next delivery time for the selected content 54 may be determined from the delivery schedule data 38 in the selected content metadata 14 or from other delivery schedule data communicated from the media distribution system 10.

FIG. 8 is a detailed description of a media content presentation module 60, according to an aspect. The media content presentation module 60 includes content presentation logic 86 operable to determine an optimal time for presenting the received selected media content 54. The determination of an optimal presentation time may be based on one of various presentation attributes, including, but not limited to, metadata 14 in the selected content 54, storage attributes 140 related to the selected content, the user profile 46, dynamic user usage data 142 and the like. Metadata 14 may include presentation attributes, such as specific presentation times and/or dates, specific number of times the content is to be played, a presentation priority indicator, a content ranking indicator or the like. Storage attributes 140 may include the expiration date of the content, the remaining storage life of the content, the number of times the content has been presented, the number of times remaining for the content to be presented and the like. The user profile 46 may include active user data 48 and/or user inference 50 data that may be applicable to when and/or where selected media content 54 is presented. Dynamic user usage data 142 may include the current location of the device, the current time of day/day of week, the primary content 144, application or network service currently being accessed or executed. In this regard, the content presentation logic 86 may be configured to present the selected content 54 based a correlation between the primary content 144, application or network service currently being accessed or executed. Additionally, the content metadata may dictate that the content be presented at a specified time of the day/day of the week or at a specific geographic location.

The content presentation module 60 may additionally include content aging logic 88 operable for determining the age or expiration date of selected media content 54 and purging the content from wireless device memory in accordance with the age or expiration determination. The storage capacity on the wireless device is limited and, therefore, the amount of selected content 54 that a device can receive and store is limited. Aging of the selected content can be determined based on one or more aging attributes 146. Aging attributes 146 may include, but are not limited to, data such as an expiration date, a content ranking attribute included in the metadata 14 of the selected content 54, a correlation ranking that ranks the selected content according to how strong the correlation is between the selected media content 54 and the user profile 46

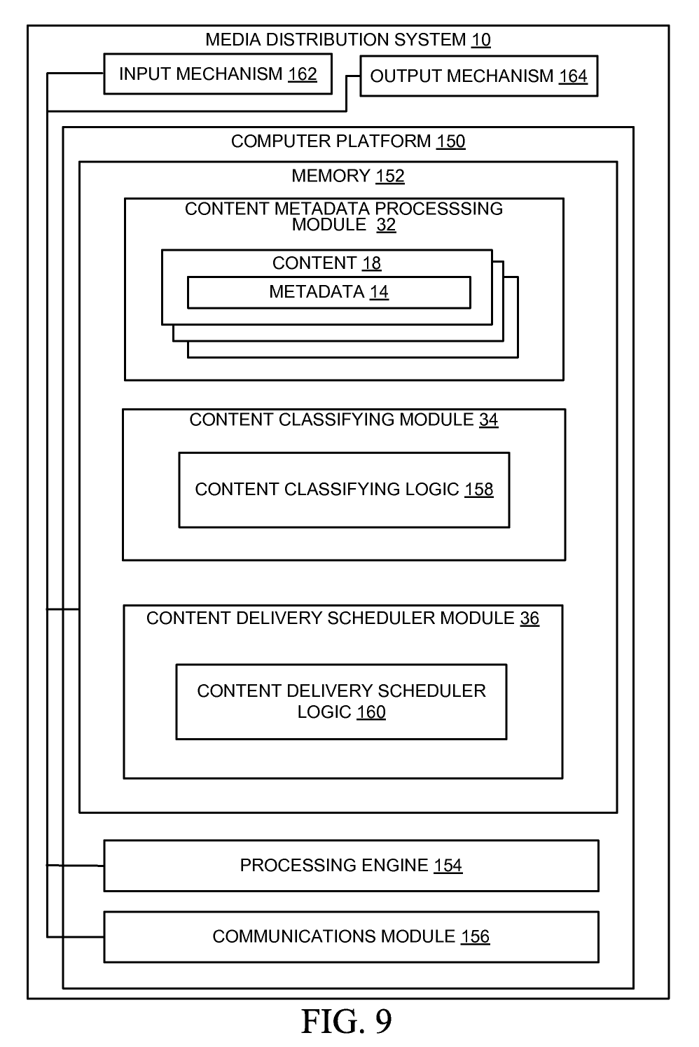

FIG. 9 is a detailed block diagram of a media content distribution system 10. The media content distribution system 10 may comprise at least one of any type of hardware, server, personal computer, mini computer, mainframe computer, or any computing device either special purpose or general computing device. Further, the modules and applications described herein as being operated on or executed by the media content distribution system 10 may be executed entirely on a single network device, as shown in FIG. 9, or alternatively, in other aspects, separate servers, databases or computer devices may work in concert to provide data in usable formats to parties, and/or to provide a separate layer of control in the data flow between the wireless communication devices 16 and the modules and applications executed by the media content distribution system 10.

The media content distribution 10 includes computer platform 150 that can transmit and receive data across data network 30, and that can execute routines and applications. Computer platform 150 includes a memory 152, which may comprise volatile and nonvolatile memory such as read-only and/or random-access memory (RAM and ROM), EPROM, EEPROM, flash cards, or any memory common to computer platforms. Further, memory 152 may include one or more flash memory cells, or may be any secondary or tertiary storage device, such as magnetic media, optical media, tape, or soft or hard disk. Further, computer platform 150 also includes a processor 154, which may be an application-specific integrated circuit (“ASIC”), or other chipset, logic circuit, or other data processing device.

The computer platform 150 further includes a communications module 156 embodied in hardware, firmware, software, and combinations thereof, that enables communications among the various components of media content distribution system 10, as well as between the content distribution system 10 and wireless communication devices 16. The communication module 156 may include the requisite hardware, firmware, software and/or combinations thereof for establishing a wireless communication connection. According to described aspects, the communication module 156 may include delivery mechanism 26 (FIG. 1) operable to broadcast, multicast or otherwise deliver metadata 14, delivery schedule data 38, and media content 18 to wireless devices 16.

The memory 152 of media content distribution system 10 also includes content metadata processing module 32. Content metadata processing module 32 is operable for creating metadata 14 for each of the plurality media content 18. The media content metadata processing module 30 may be configured to create all or a portion of metadata 14 automatically according to associated logic, or the metadata 14 may be manually inputted by a media distribution operator using an appropriate input mechanism 162, such as keyboard, in conjunction with an output mechanism 164, such as a display, or the metadata 14 may be received from a third party, such as content provider 22 (FIG. 1). In accordance with present aspects, the metadata 14 may include attributes that characterize the media content 18 for targeted wireless devices 16. Attributes may include, but are not limited to, targeted viewer gender, targeted viewer income, targeted viewer education, targeted viewer age range, targeted viewer geographic location, content characteristics, such as audio data, video data, multimedia data, content type, such as advertising content, size/length in time of the content, required bandwidth for delivering the content, priority/service level of the content and the like.

The memory 152 of media distribution system 10 may also include a media content classifier module 34 that includes content classifying logic 158 that is operable for classifying the plurality of media content 18 into one or more media content groups 12. In some aspects, the characteristics of each group may be predetermined, whereas in other aspects, the group may be assembled in an ad hoc basis according to common and/or related characteristics among a given plurality of content. The content classifier logic 158 may include a heuristic algorithm or the like that classifies some or a portion of the plurality of media content into content groups based on the metadata 14. For example, content that is targeted for the same group of users is grouped together. In alternate aspects, classification may involve some level of manual input from a media distribution operator. Grouping of media content allows the media distribution system 10 to subsequently communicate the media content 18 that forms the group 12 together. As such, a wireless device 16 that desires to acquire media content 18 from the group 12 needs to wake up less to receive relevant media content and hence saves the wireless device in terms of standby time and battery power consumption. The media content classifier module 34 may also be operable for delivering metadata 14 associated with the grouped content to the plurality of wireless devices 16.

The memory 152 of media distribution system 10 may also include a content delivery scheduler 36 that includes content delivery scheduler logic 160 operable for determining a delivery schedule 38 for media content groups 12. The content delivery scheduler logic 160 may determine a delivery schedule 38 for media content groups based one or more delivery attributes 40.

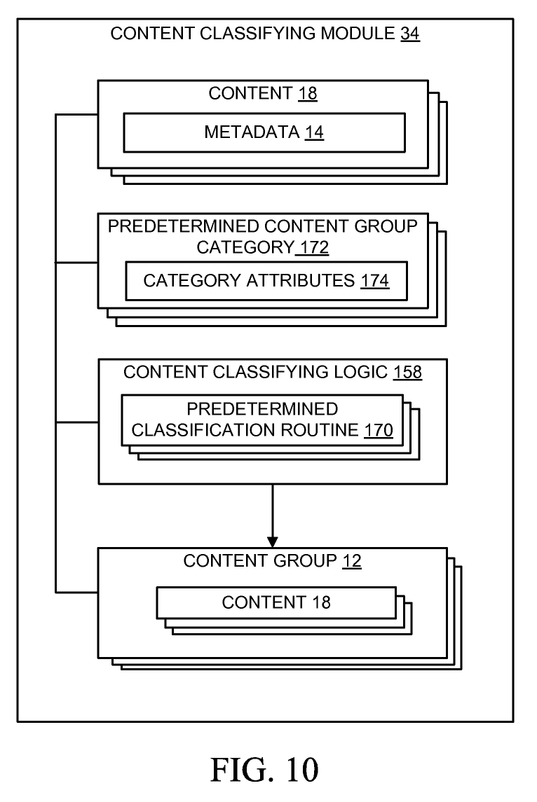

FIG. 10 is a detailed block diagram of the content classifier module 34, according to an aspect. The content classifier module 34 includes content classifying logic 158 that executes one or more predetermined classification routines 170. The classification routines are operable to classify, otherwise referred to herein as group, content 18 into one or more predetermined content group categories 172 by making correlations between the metadata 14 associated with the content 18 and category attributes 174 associated with predetermined content group categories 170. Relevant content metadata 14 may include, but is not limited to, targeted viewer gender, targeted viewer income, targeted viewer education, targeted viewer age range, targeted viewer geographic location, content characteristics, such as audio data, video data, multimedia data, content type, such as advertising content, size/length in time of the content, required bandwidth for delivering the content, priority/service level of the content and the like. Thus, category attributes 174 may include attributes corresponding to the metadata, for example, gender, age range, income range, education, geographic location, content characteristics, content type, content of a specific length/size, content of a specific priority or service level, and the like. The content classifying logic 158 determines which content group categories 170 a specific content item 18 falls under, and forms content groups 12 that include content 18 based on the determination. As such, each content item 18 can be assigned to multiple content groups 18.

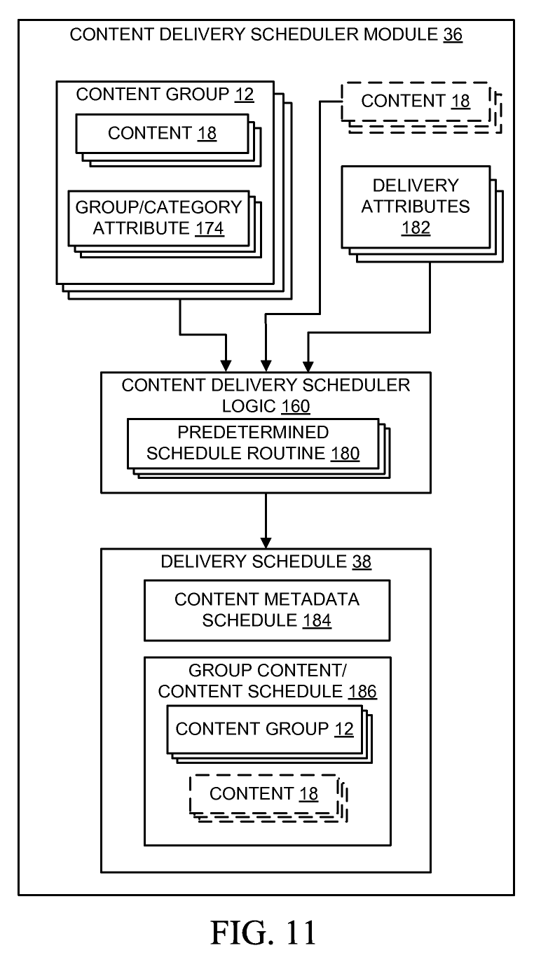

Referring to FIG. 11, a detailed block diagram of a content delivery scheduler module 36. The schedule content delivery scheduler module includes content delivery scheduler logic 160 that includes one or more predetermined schedule routines 180 operable for determining a delivery schedule for content groups 12 and optionally, in some aspects, individual content items 18. Content delivery schedule logic 160 utilizes group category attributes 174, and delivery attributes 182 to determine delivery schedule 38. In those alternate aspects, in which the content delivery schedule module 36 also provides a schedule for individual content items 18, the delivery schedule logic 180 may use metadata 14 to determine delivery schedule 38. Delivery attributes 182 include, but are not limited to, service level for content providers, delivery cost paid by the content providers, potential number of targeted wireless devices, delivery time of day/week, delivery reliability factors, amount of bandwidth required to deliver the content group. These factors assist in determine the amount of redundancy needed for content 18 and/or content groups 12, the quantity of delivery repetitions, the delivery time and the like.

The content delivery schedule logic 160 is operable to provide a content schedule 38. The content schedule 38 may include a content metadata schedule 184 and a group content/content schedule 186. The content metadata schedule 184 provides for delivering the content metadata associated with a group at predetermined times. Content metadata 14 is delivered to wireless communication devices prior to transmission of the content 18 to allow the wireless communication devices 16 to determine which media content to acquire from the associated content group. The group content/content schedule 186 provides for a schedule for the delivery of content groups 12 and, in some aspects, individual content items 18.

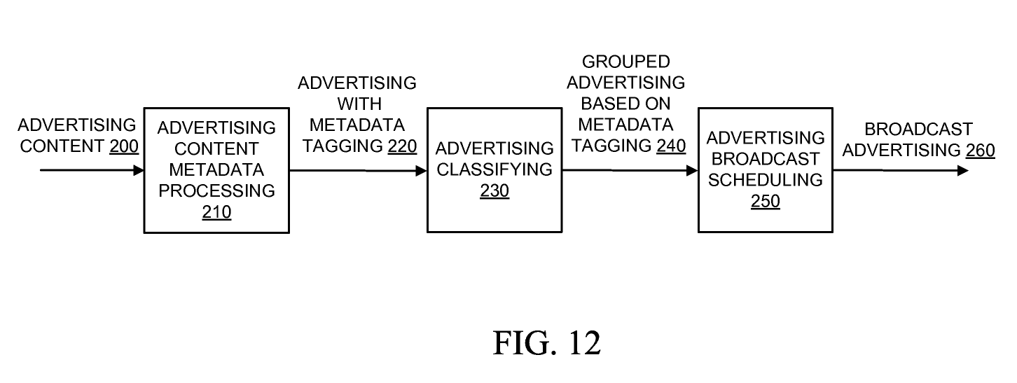

FIG. 12 provides a flow diagram of one specific aspect for grouping and delivering targeted advertising content to wireless devices. At Event 200, advertising content is delivered from one or more service providers to a media content distribution system. At Event 210, advertising content metadata processing occurs, whereby metadata is provided to content and, in particular, metadata that associates the advertising content with a targeted user/wireless device. As previously noted, advertising content metadata processing will typically involve manual inputs by a media content distribution system operator.

At Event 220, the resulting advertising content with associated metadata tagging is communicated to the advertising classifier. At Event 230, the advertising content is classified into advertising content groups based on correlations between predetermined advertising content group categories having associated category attributes and the metadata associated with the advertising content.

At Event 240, the grouped advertising content is communicated to the advertising broadcast/multicast scheduler. At Event 250, an advertising broadcast schedule is determined for the groups of advertising content. Scheduling of the groups of advertising content may involve determine redundancy, repetition and delivery times based on delivery attributes, content metadata and content group attributes. At Event 260, once the schedule has been determined, the grouped advertising content is broadcasted/multicasted according to the determined schedule.

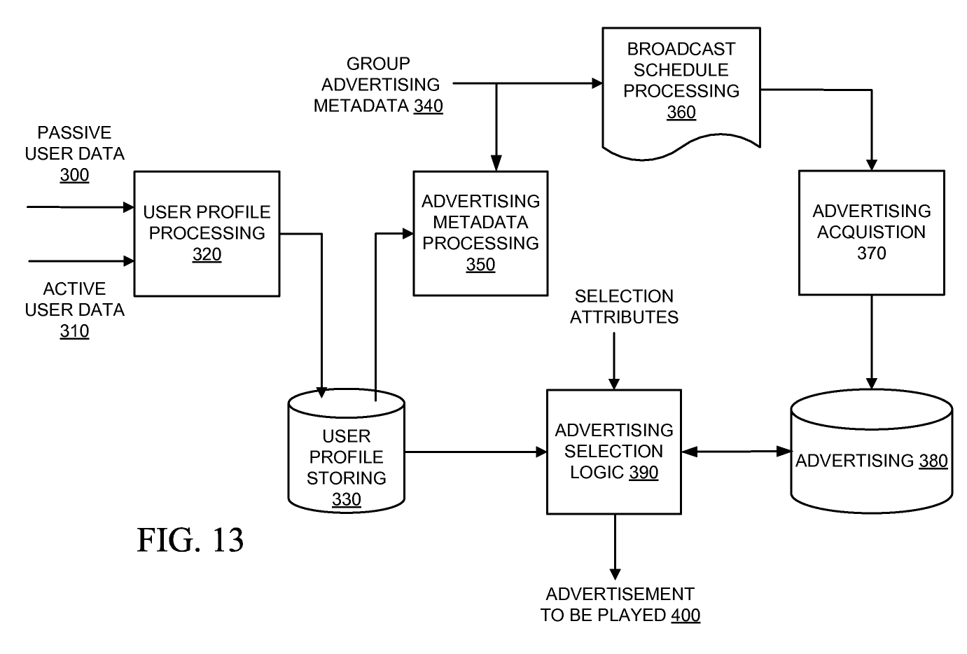

FIG. 13 provides a flow diagram of one specific aspect for determining targeted advertising content on a wireless communication device. At Event 300, passive user data is provided to a user profile processor and, at Event 310, active user data is provided to a user profile processor. At Event 320, user profile processing is implemented to provide for a user profile. Additionally, user inferences may be determined and included within the user profile. The user profile may include passive user data, active user data, and/or user inference data that are used in determining which advertising content to target for acquisition.

Once the user profile has been determined, at Event 330, the user profile is stored in memory. It should be noted that certain user profile data, in particular active profile data and user inference data, will have aging attributes that require such data to be deleted from the profile after a predetermined period of time. In addition, since the user profile includes dynamic active data and dynamic user inference data, the stored user profile will frequently require updating.

At Event 340, advertising metadata is received at the wireless device and, at Event 350, advertising metadata processing occurs to determine correlations between the user profiles and the metadata associated with advertising content. Determined correlations between the user profile and the advertising metadata result in selected advertising. At Event 360, a broadcast schedule for the selected advertising is determined based on delivery attributes in the metadata. At Event 370, the advertising content is acquired by triggering the wireless device to “wake-up” at times determined in accordance with the determined delivery schedule. At Event 380, the received advertising content is stored in device memory. In most aspects, the advertising content will have an aging attribute that defines the expiration date of the advertising content.

At Event 390, the advertising content selection processing determines the time, location and/or corresponding primary content, application or network service for presenting the advertising content. The advertising selection content processing determination may rely on user profile data and/or advertising presentation attributes in determine when and where to present the advertising content. At Event 400, the advertising content is presented on the wireless device, according to the determined presentation.

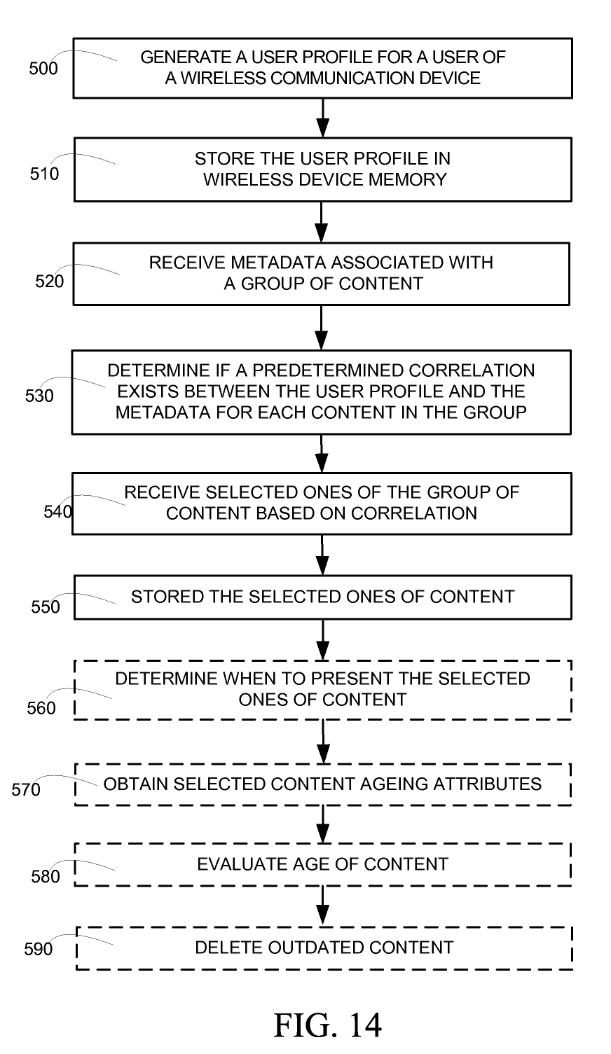

Referring to FIG. 14, a flow diagram is presented of a method for acquiring targeted media content on a wireless device. At Event 500, the wireless device generates a user profile that includes any combination of passive user data, active user data and/or user inference data. The user profile will characterize include passive, active and inference attributes for targeting specific media content for acquisition. At Event 510, the user profile is stored in wireless device memory. The dynamic nature of the user data in the profile will typically require that the data in the profile be updated on an ongoing and continual basis. Additionally, attributes in the user profile may include an aging attribute for removing user data in the profile based on an expiration date or the like.

At Event 520, the wireless device receives metadata associated with a group of content and, at Event 530, the wireless device determines a predetermined correlation between user data in the user profile and the metadata for each content item in the group. A correlation between the user data in the profile and the metadata will result in selected media content, otherwise referred to as media content targeted for acquisition. A result of the correlation and determination of selected media content, a delivery schedule for the selected content may be determined based on metadata in the selected content.

At Event 540, the wireless device receives the selected ones of the group of content based on the correlation. Receiving the selected content may involve triggering the wireless device to “wake-up” to receive a broadcast or multicast of the selected time at a specified delivery time. At Event 550, the wireless device stores the received selected media content in wireless device memory.

At optional Event 560, the wireless device determines when to present the received and selected ones of the media content. Determining when to present the media content may include determining a time, determining a location and/or determining what primary content, application or network service to present the selected content in conjunction with. Determining when to present the content may be based on content metadata, group metadata, storage attributes and/or dynamic data related to presentation.

At optional Event 570, the method may include obtaining an aging attribute for the selected content and, at optional Event 580, determining the age of selected content, or the number of presentations of the content, or any other characteristic, such as the service level of the content or the like, related to aging of the selected contact. At optional Event 590, expired or otherwise aged selected content is deleted from wireless device memory.

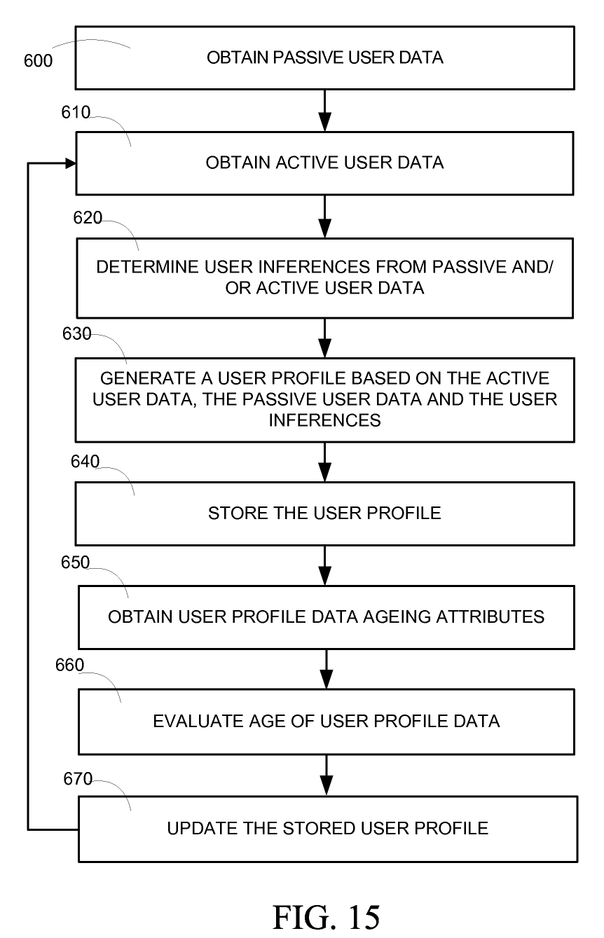

Referring to FIG. 15, presented is a method for providing a user profile to be used for targeted media content acquisition on a wireless device. At Event 600, the wireless device obtains passive profile data. Passive user data is typically obtained by providing the user with a survey or questionnaire of user queries. At Event 610, the wireless device obtains active user profile data, active user data may be obtain via heuristic algorithms that monitor the time and location of user activities, user access to content, user execution of applications, user access to network services and the like. Active user profile data may be historical data related to user usage behavior or the active user profile data may be dynamic data related to current user usage. At Event 620, the wireless device determines user inferences based on one or more of the passive user data items or the active user data items. User inferences may be logically determined by applying one or more inference routines having one or more inference rules defining the inference.

At Event 630, the user profile is generated based on the passive user data, the active user data and the user inferences. The user profile will include attributes that are used to determining targeted media content to acquire on the wireless device. At Event 640, the user profile is stored in wireless device memory.

At Event 640, aging attributes associated with data in the user profile are obtained. Characteristically the active user profile data and the user inference data will have limited applicability in terms of time. In some aspects dynamic active user data and/or user inferences will only remain in the user profile for the duration of the activity or event that the user is currently experiencing. At Event 650, the age or expiration date of the user profile is evaluated and compared to the associated aging attribute. At Event 660, based on expired or aged data in the user profile, the user profile is updated with new active profile data and/or user inferences by returning the flow to Event 610.

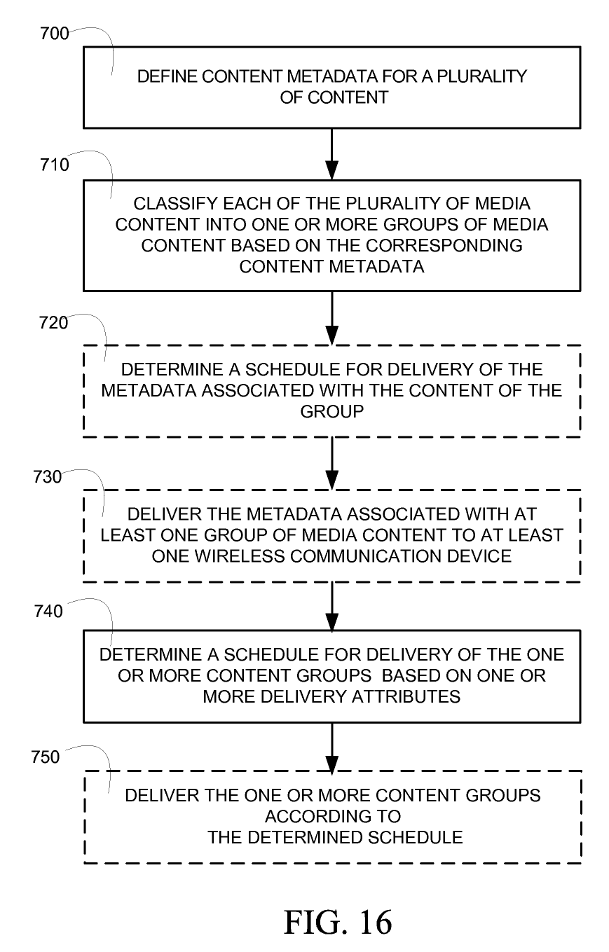

Referring to FIG. 16, presented is a method for grouping media content at a media content distribution system for targeted media content acquisition on a wireless device. At Event 700, metadata is defined for a plurality of media content. Typically, metadata will manually inputted by a media content distribution representative and/or a service provider representative. At Event 710, the media content is classified or grouped into one or more content groups based on a correlation between the group attributes and the content metadata. At optional Event 720, a delivery schedule for delivery of the metadata associated with content group is determined and, at optional Event 730, the metadata is delivered to wireless communication devices. In turn, the metadata is implemented at the wireless devices to determine which of the content on the content group the device would like to acquire.

At Event 740, the media content distribution system determines a schedule for the delivery of the content group based on one or more delivery attributes and/or content metadata related to delivery and, at optional Event 750, the media content is delivered to the wireless devices according to the determined delivery schedule.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

Thus, present aspects provide for devices, apparatus, systems, methods and computer program products for targeted media content acquisition on a wireless device. The wireless devices select media content to receive locally, at the wireless device, based on a user profile that may include passive user data, active user data and user inferences drawn from the passive and active user data. By selecting the media content locally, the wireless device does not have to supply personal information to the network, thereby, maintaining a level of user privacy. By using passive and active user data, in addition to user inferences, the media content that is acquired by the wireless device is limited to media content that is highly tailored to the user and the user's current actions. Additionally, aspects provide for grouping of the media content at the network device, so that metadata associated with the group and the media content within a group can be communicated unison to limit number of times that a wireless device needs to wake-up to receive the media content, thereby, limiting power consumption.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for targeted media content acquisition on a wireless communication device, comprising:
generating one or more user profiles for users of a wireless communication device, wherein each user profile includes user data;
storing the one or more user profiles in a wireless communication memory;
receiving metadata associated with a group of media content, wherein the group of media content is based on a predetermined match between group characteristics and media content metadata;
determining a correlation between the user data in one or more user profiles and the metadata;
generating a schedule to listen for selected media content from the group of media content based on the correlation between the user data and the metadata; and
storing the schedule in the wireless communication device memory.

2. The method of claim 1, wherein generating one or more user profiles that include user data further comprises determining user inference data based on at least one of passive user data and active user data.

3. The method of claim 2, wherein generating one or more user profiles that include user data further defines the user data as passive user data, active user data and user inference data.

4. The method of claim 1, wherein determining a correlation between the user data in one or more user profiles and the metadata further comprises determining user inference data based on the user data in one or more user profiles.

5. The method of claim 4, further comprising determining a correlation between the user inference data and the metadata.

6. The method of claim 1, further comprising receiving the selected media content from the group of media content and storing the selected media content in wireless communication device memory.

7. The method of claim 6, wherein receiving the selected media content further comprises triggering the wireless communication device to wake-up at predetermined times based on the generated schedule.

8. The method of claim 6, further comprising determining when to present received ones of the selected media content on the wireless communication device.

9. The method of claim 8, wherein determining when to present received ones of the selected media content further comprises determining when to present received ones of the media content based on one or a combination of the user data in the user profile, the metadata corresponding to the selected media content, and dynamic user use data.

10. The method of claim 9, wherein determining when to present received ones of the selected media content based on dynamic user use data further comprises dynamic user use data based on at least one of current media content being presented on the wireless communication device, current location of the user and current time.

11. The method of claim 6, further comprising monitoring an expiration attribute for each of the received selected media content.

12. The method of claim 11, further comprising deleting selected ones of the received selected media content from the wireless communication device memory based on monitoring the expiration attribute and determining that selected ones of the received selected media content have expired.

13. At least one processor for targeted media content acquisition on a wireless communication device, comprising:
a first module for generating one or more user profiles for users of a wireless communication device, wherein each user profile includes user data;
a second module for storing the one or more user profiles in a wireless communication device memory;
a third module for receiving metadata associated with a group of media content, wherein the group of media content is based on a predetermined match between group characteristics and media content metadata;
a fourth module for determining a correlation between the user data in one or more user profiles and the metadata;
a fifth module for generating a schedule to listen for selected media content from the group of media content based on the correlation between the user data and the metadata; and
a sixth module for storing the schedule in the wireless communication device memory.

14. A computer program product for targeted media content acquisition, comprising:
a computer-readable medium comprising:
a first set of codes for causing a computer to generate one or more user profiles for users of a wireless communication device, wherein each user profile includes user data;
a second set of codes for causing the computer to store the one or more user profiles in a memory;
a third set of codes for causing the computer to receive metadata associated with a group of media content, wherein the group of media content is based on a predetermined match between group characteristics and media content metadata;
a fourth set of codes for causing the computer to determine a correlation between the user data in one or more user profiles and the metadata;
a fifth set of codes for causing the computer to generate a schedule to listen for selected one of media content from the group of media content based on the correlation between the user data and the metadata; and
a sixth set of codes for causing the computer to store the schedule in the memory.

15. A wireless communication device for targeted media content acquisition, comprising:
means for generating one or more user profiles for users of a wireless communication device, wherein each user profile includes user data;
means for storing the one or more user profiles in a wireless communication device memory;
means for receiving metadata associated with a group of media content, wherein the group of media content is based on a predetermined match between group characteristics and media content metadata;
means for determining a correlation between the user data in one or more user profiles and the metadata;
means for generating a schedule to listen for selected media content from the group of media content based on the correlation between the user data and the metadata; and
means for storing the schedule in the wireless communication device memory.

16. A wireless communication device, comprising:
a computer platform including a processor and a memory;
a user profile module stored in the memory and executable by the processor, wherein the user profile module includes user profile logic operable to generate one or more user profiles that include user data, and operable to store the one or more user profiles in the memory;
media content metadata processing module stored in the memory and executable by the processor, wherein the media content metadata processing module includes media content metadata processing logic operable to receive metadata associated with a group of media content, wherein the group of media content is based on a predetermined match between group characteristics and media content metadata, determine a correlation between the user data and the metadata, generate a schedule for listening for selected media content from the group of media content based on the correlation, and store the schedule in the memory.

17. The wireless communication device of claim 16, wherein the user profile logic is further operable to determine one or more user inferences based on at least one of passive user data and active user data.

18. The wireless communication device of claim 17, wherein the user profile logic is further operable to generate one or more user profiles that include passive user data, active user data and user inference data.

19. The wireless communication device of claim 16, wherein the media content metadata processing logic is further operable to determine one or more user inferences based on the user data.

20. The wireless communication device of claim 19, wherein the media content metadata processing logic is further operable to determine a correlation between the one or more user inferences and the metadata.

21. The wireless communication device of claim 16, further comprising a media content acquisition module stored in the memory and executable by the processor, wherein the media content acquisition module includes media content acquisition logic operable to receive the selected media content from the group of media content and store the received selected media content in the memory.

22. The wireless communication device of claim 21, wherein the media content acquisition logic is further operable to trigger the wireless communication device to wake-up at predetermined times based on the generated schedule.

23. The wireless communication device of claim 21, further comprising a media content presentation module stored in the memory and executable by the processor, wherein the media content presentation module includes media content presentation logic operable to determine when to present received selected media content based on one or a combination of the user data, media content metadata and dynamic user usage data.

24. The wireless communication device of claim 23, wherein the dynamic user usage data is further defined as being based on at least one of current media content being presented on the wireless communication device, current location of the user and current time.

25. The wireless communication device of claim 16, wherein the media content presentation logic is further operable to monitor an expiration attribute for each of the received selected media content.

26. The wireless communication device of claim 25, wherein the media content presentation logic is further operable to delete from the memory selected ones of the received selected media content based on monitoring the expiration attribute for each of the received selected media content and determining that selected ones of the received selected media content have expired.

27. A method for delivering media content in a communication network, comprising:
obtaining metadata for a plurality of media content;
classifying each of the plurality of media content into one or more groups of media content based on the metadata;
determining a schedule for communicating the one or more groups of media content based on one or more delivery attributes; and
storing the schedule in a network database.

28. The method of claim 27, further comprising communicating the one or more groups of media content according to the determined schedule.

29. The method of claim 27, further comprising communicating the metadata to a plurality of wireless communication devices prior to communicating the one or more groups of media content according to the determined schedule.

30. The method of claim 27, wherein obtaining metadata for a predetermined plurality of media content further comprises obtaining target attributes that characterize the media content for a targeted recipient.

31. The method of claim 27, wherein obtaining metadata further comprises obtaining metadata related to at least one of targeted gender, targeted income, targeted education, targeted age, targeted geographic location, media content type, media content size, required bandwidth for wireless transmission, media content characteristics, and expiration date.

32. The method of claim 27, wherein classifying each of the predetermined plurality of media content into one or more groups of media content based on the metadata further comprises classifying based on a predetermined classification routine.

33. The method of claim 27, wherein determining a schedule for communicating the one or more groups of media content based on one or more delivery attributes further comprises determining based on the delivery attributes comprising at least one of available network resources, priority of media content, priority of the group of media content, required time of day for delivery, value of the media content, value of the group of media content, and potential quantity of wireless communication devices to whom the group of media content is to be communicated.

34. The method of claim 27, wherein determining a schedule further comprises determining an amount of redundancy needed to be added to the group of media content.

35. The method of claim 27, wherein determining a schedule further comprises determining a number of repetitions for communicating the group of media content.

36. The method of claim 27, wherein determining a schedule further comprises determining one or more communication times for the group of media content.

37. At least one processor configured for delivering media content in a communication network, comprising:
a first module for obtaining metadata for a plurality of media content;
a second module for classifying each of the plurality of media content into one or more groups of media content based on the metadata;
a third module for determining a schedule for communicating the one or more groups of media content based on one or more delivery attributes; and
a fourth module for storing the schedule in a network database.

38. A computer program product for delivering media content in a communication network, comprising:
a computer-readable medium comprising:
a first set of codes for causing a computer to obtain metadata for a plurality of media content;
a second set of codes for causing the computer to classify each of the plurality of media content into one or more groups of media content based on the metadata;
a third set of codes for causing the computer to determine a schedule for communicating the one or more groups of media content based on one or more delivery attributes; and
a fourth set of codes for causing the computer to store the schedule in a network database.

39. A device for delivering media content in a communication network, comprising:
means for obtaining metadata for a plurality of media content;
means for classifying each of the plurality of media content into one or more groups of media content based on the metadata;
means for determining a schedule for communicating the one or more groups of media content based on one or more delivery attributes; and
means for storing the schedule in a network database.

40. A network device, comprising:
a computer platform including a processor and a memory;
media content processing logic operable to obtain metadata for a plurality of media content;
media content classifying logic operable to classify each of the plurality of media content into one or more groups of media content based on the metadata; and
a media content scheduler operable to determine a schedule for communicating the one or more groups of media content based on one or more communication attributes.

41. The device of claim 40, further comprising a communication module operable to communicate the one or more groups of media content according to the determined schedule.

42. The device of claim 40, further comprising a communications module operable to communicate metadata associated with the one or more groups of media content.

43. The device of claim 40, wherein the metadata comprises attributes that characterize the media content for a target recipient.

44. The device of claim 40, wherein the metadata comprises at least one of targeted gender, targeted income, targeted education, targeted age, targeted geographic location, media content type, media content size, required bandwidth for wireless transmission, media content characteristics, and expiration date.

45. The device of claim 40, wherein the one or more communication attributes comprise at least one of available network resources, priority of media content, priority of the group of media content, required time of day for delivery, value of the media content, value of the group of media content, and potential quantity of wireless communication devices to whom the group of media content is to be communicated.

46. The device of claim 40, wherein the media content scheduler is further operable to determine an amount of redundancy needed to be added to the group of media content.

47. The device of claim 40, wherein the media content scheduler is further operable to determine a number of repetitions for communicating the group of media content.

48. The device of claim 40, wherein the media content scheduler is further operable to determine one or more communication times for the group of media content.
